(19) United States
(12) Patent Application Publication
(10) Pub. No.: US 2024/0292101 A1
(43) Pub. Date: Aug. 29, 2024

(54) SHAKE CORRECTION DEVICE AND IMAGING APPARATUS

(71) Applicant: FUJIFILM Corporation, Tokyo (JP)

(72) Inventors: Takuro ABE, Saitama (JP); Kouhei AWAZU, Saitama (JP)

(73) Assignee: FUJIFILM Corporation, Tokyo (JP)

(21) Appl. No.: 18/586,581

(22) Filed: Feb. 26, 2024

(30) Foreign Application Priority Data
Feb. 28, 2023 (JP) 2023-030139

(51) Int. Cl. H04N 23/68; H04N 23/54

(52) U.S. Cl. CPC H04N 23/687; H04N 23/54

(57) ABSTRACT

Provided are a shake correction device and an imaging apparatus reduced in size.

A shake correction device that drives an imaging element by an actuator to perform shake correction includes a fixed unit that includes a first fixing member provided with a magnet and a yoke of the actuator; a movable unit that includes a holding frame holding the imaging element and a coil of the actuator and is configured to move within a plane intersecting an optical axis; and a biasing unit that biases the movable unit toward the first fixing member by point contact along an optical axis direction, in which the actuator is disposed on a rear surface of the imaging element.

### CROSS-REFERENCE TO RELATED APPLICATION

The present application claims priority under 35 U.S.C § 119(a) to Japanese Patent Application No. 2023-030139 filed on Feb. 28, 2023, which is hereby expressly incorporated by reference, in its entirety, into the present application.

### BACKGROUND OF THE INVENTION

### 1. Field of the Invention

The present invention relates to a shake correction device and an imaging apparatus.

### 2. Description of the Related Art

In the related art, there has been proposed a technology of a camera in which a shake correction device for suppressing a shake such as a camera shake is attached to an image sensor.

For example, JP2016-170339A discloses a technology related to a shake correction device mainly composed of a fixed unit fixed to a camera body, a movable unit that holds an image sensor, and a support unit that supports the movable unit to be movable in a plane perpendicular to an optical axis.

Further, for example, JP2020-170963A discloses a technology for suppressing an influence of a magnetic field from a coil constituting a voice coil motor driving a movable unit of a shake correction device.

### SUMMARY OF THE INVENTION

An embodiment according to a technology of the present disclosure provides a shake correction device and an imaging apparatus reduced in size.

According to a first aspect of the present invention, there is provided a shake correction device that drives an imaging element by an actuator to perform shake correction, the shake correction device comprising: a fixed unit that includes a first fixing member provided with a magnet and a yoke of the actuator; a movable unit that includes a holding frame holding the imaging element and a coil of the actuator and is configured to move within a plane intersecting an optical axis; and a biasing unit that biases the movable unit toward the first fixing member by point contact along an optical axis direction, in which the actuator is disposed on a rear surface of the imaging element.

According to a second aspect, in the first aspect, preferably, the imaging element and the actuator are provided in a positional relationship in which a projection region of the imaging element in a thickness direction and at least a part of the actuator overlap with each other.

According to a third aspect, in the first aspect, preferably, a first flexible circuit connected to the actuator and a second flexible circuit connected to the imaging element are attached to a side surface of the holding frame.

According to a fourth aspect, in the third aspect, preferably, the holding frame includes at least a first side surface and a second side surface intersecting the first side surface, and the first flexible circuit is attached to the first side surface, and the second flexible circuit is attached to the second side surface.

According to a fifth aspect, in the third aspect, preferably, at least one of the first flexible circuit or the second flexible circuit is attached while having a bent portion, and the bent portion changes following movement of the holding frame.

According to a sixth aspect, in the third aspect, preferably, a controller that inputs a drive signal for suppressing resonance of the movable unit to the actuator is further provided.

According to a seventh aspect, in the sixth aspect, preferably, a temperature acquisition unit that acquires an environmental temperature is further provided, and the drive signal is input to the actuator based on the environmental temperature acquired by the temperature acquisition unit.

According to an eighth aspect, in the seventh aspect, preferably, the controller selects the drive signal from among a plurality of the drive signals based on the environmental temperature and inputs the selected drive signal to the actuator.

According to a ninth aspect, in the first aspect, preferably, the biasing unit includes a ball plunger.

According to a tenth aspect, in the first aspect, preferably, a hall sensor that detects a position of the imaging element is further provided, the magnet of the actuator is used as a magnet that generates a magnetic field detected by the hall sensor, and a hall element constituting the hall sensor is disposed inside the coil of the actuator.

According to an eleventh aspect, in the tenth aspect, preferably, the magnet of the actuator is a magnet portion composed of a pair of magnets disposed at a first gap on the yoke, and opposing corner portions of distal end portions of the pair of magnets are cut, and a second gap between the distal end portions is wider than the first gap.

According to a twelfth aspect, in the first aspect, preferably, an electromagnetic wave shielding member is disposed between a rear surface side of the imaging element and the coil.

According to a thirteenth aspect, in the first aspect, preferably, the actuator is a voice coil motor.

According to a fourteenth aspect, there is provided an imaging apparatus comprising the shake correction device according to any one of the first to thirteenth aspects.

### BRIEF DESCRIPTION OF THE DRAWINGS

FIG. 1 is a schematic view of an inside of an imaging apparatus equipped with a shake correction device.

FIG. 2 is a block diagram showing an embodiment of an internal configuration of the imaging apparatus.

FIG. 3 is a front perspective view of the shake correction device.

FIG. 4 is a rear perspective view of the shake correction device.

FIG. 5 is a front perspective view of a fixed unit constituting the shake correction device.

FIG. 6 is a front perspective view of a movable unit constituting the shake correction device.

FIG. 7 is a cross-sectional view schematically showing a cross section taken along the line A-A shown in FIG. 3.

FIG. 8 is a schematic view for explaining disposition positions of a first FPC and a second FPC.

FIG. 9 is a view schematically showing shapes of the first FPC and the second FPC.

FIG. 10 is a view for explaining a Lorentz force acting on a winding coil.

FIG. 11 is a schematic view of a case where the movable unit is biased by a general magnetic spring.

FIG. 12 is a view schematically showing a cross section taken along the line B-B in FIG. 4.

FIG. 13 is a view schematically showing a cross section taken along the line C-C in FIG. 4.

FIG. 14 is a view for explaining a disposition position of a biasing unit.

FIG. 15 is a schematic view illustrating disposition of a hall sensor and a magnet shape.

FIG. 16 is a view showing a relationship between a magnet gap W and a linearity error.

FIG. 17 is a view showing a relationship between linearity errors of forms shown in (A) and (B) of FIG. 15.

FIG. 18 is a view showing a modification example of a chamfer shape of a magnet.

FIG. 19 is a view showing a relationship between a temperature change and a primary resonance frequency of the shake correction device.

FIG. 20 is a view schematically showing a one-side half of the second FPC 123 shown in FIG. 9.

FIG. 21 is a view showing an example of a displacement in a Y direction and a reaction force of a flexible printed circuit.

FIG. 22 is a view for explaining a disposition position of a hall element.

FIG. 23 is a rear perspective view of a shake correction device of the related art.

### DESCRIPTION OF THE PREFERRED EMBODIMENTS

Hereinafter, preferred embodiments of a shake correction device and an imaging apparatus according to the present invention will be described with reference to the accompanying drawings.

### Imaging Apparatus

An imaging apparatus equipped with a shake correction device that suppresses an image shake in an image to be obtained, due to a shake such as a camera shake, will be described.

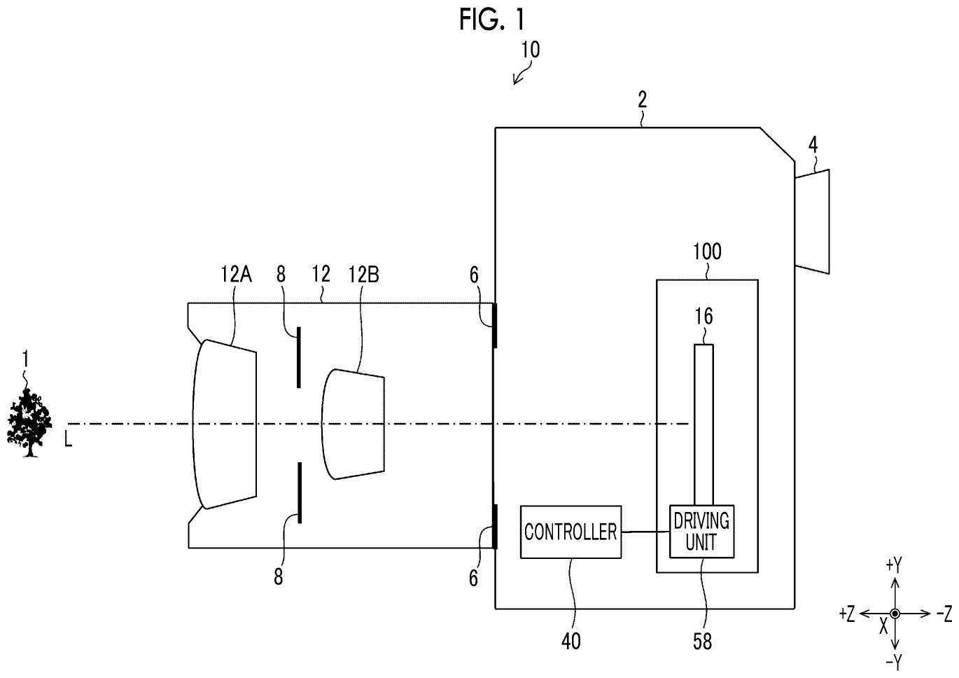

FIG. 1 is a schematic view of an inside of an imaging apparatus 10 that is equipped with a shake correction device 100 of the embodiment of the present invention.

The imaging apparatus 10 is a lens-interchangeable camera, and an imaging lens device 12 is mounted on the imaging apparatus main body 2 via an adapter 6. The imaging lens device 12 comprises a stop 8 and lens groups 12A and 12B. The imaging lens device 12 having an optical axis L forms an image of light reflected by a subject 1. The imaging apparatus main body 2 comprises an eyepiece portion 4, and an imager places his/her eye on the eyepiece portion 4 to image the subject 1 in a case of imaging the subject 1.

On an imaging element 16, a light-receiving surface (imaging surface) is disposed along a plane (X-Y plane) formed by two directions (X direction and Y direction) perpendicular to the optical axis L of the imaging apparatus main body 2. The imaging element 16 is held in the shake correction device 100. Further, a shake correction function is realized by a controller 40 controlling a driving unit 58 included in the shake correction device 100.

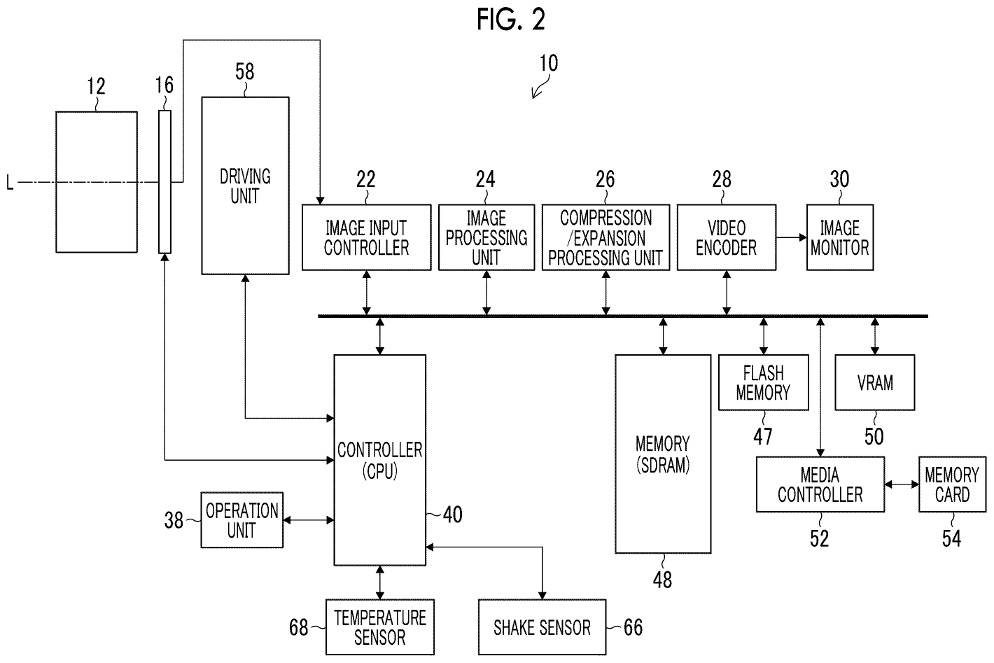

FIG. 2 is a block diagram showing an embodiment of an internal configuration of the imaging apparatus 10. The imaging apparatus 10 records a captured image in a memory card 54, and an operation of the entire apparatus is comprehensively controlled by the controller (central processing unit (CPU)) 40.

The imaging apparatus 10 is provided with an operation unit 38, such as a shutter button, a power/mode switch, a mode dial, and a cross operation button. A signal (command) from the operation unit 38 is input to the controller 40, and the controller 40 controls each circuit of the imaging apparatus 10 based on the input signal to perform drive control of the imaging element 16, lens drive control, stop drive control, imaging operation control, image processing control, recording/reproduction control of image data, display control of an image monitor 30, and the like.

A luminous flux that has passed through the imaging lens device 12 is imaged on the imaging element 16 which is a complementary metal-oxide semiconductor (CMOS) type color image sensor. The imaging element 16 is not limited to the CMOS type, and another type of image sensor, such as a charge coupled device (CCD) type or an organic imaging element, may be used.

In the imaging element 16, a large number of light-receiving elements (photodiodes) are two-dimensionally arranged, and a subject image formed on the light-receiving surface of each light-receiving element is converted (photoelectrically converted) into a signal voltage (or charge) of an amount corresponding to an amount of incidence ray, and is converted into a digital signal via an analog/digital (A/D) converter in the imaging element 16 to be output.

An image signal (image data) read from the imaging element 16 in a case of capturing a motion picture or a still picture is temporarily stored in a memory (synchronous dynamic random access memory (SDRAM)) 48 via an image input controller 22.

Further, a flash memory 47 stores various parameters and tables used for a camera control program, image processing, and the like.

A shake sensor 66 detects posture information and posture change information of the imaging apparatus 10. The shake sensor 66 is configured of, for example, a gyro sensor. The shake sensor 66 is configured of, for example, two gyro sensors to detect a camera shake amount in a vertical direction and a camera shake amount in a horizontal direction, and the detected camera shake amount (angular velocity) is input to the controller 40. Further, the shake sensor 66 includes a hall sensor described below. The controller 40 acquires a movement amount of the movable unit 101 by the hall sensor, and controls the driving unit 58 according to the movement amount. That is, the controller 40 performs shake correction by controlling the driving unit 58 to move the imaging element 16 such that the movement of the subject image corresponding to the camera shake is canceled.

A temperature sensor 68 functions as a temperature acquisition unit and measures an environmental temperature at which the imaging apparatus 10 is used. The temperature sensor 68 measures a temperature inside the imaging apparatus main body 2 and/or around the imaging apparatus main body 2. The temperature sensor 68 is configured of, for example, a known sensor that measures the temperature, such as a thermistor. Information about the environmental temperature acquired by the temperature sensor 68 is input to the controller 40. The controller 40 outputs a drive signal to the driving unit 58 based on the input environmental temperature.

The driving unit 58 is configured of an actuator that moves the movable unit 101 by an electric signal (drive signal) from the controller 40. Specific examples of the actuator include a voice coil motor. The driving unit 58 moves the movable unit 101 on the X-Y plane perpendicular to the optical axis L in response to the electric signal input from the controller 40.

An image processing unit 24 reads unprocessed image data that is acquired via the image input controller 22 in case of capturing a motion picture or a still picture and temporarily stored in the memory 48. The image processing unit 24 performs offset processing, pixel interpolation processing (interpolation processing for a phase difference detecting pixel, a defective pixel, and the like), white balance correction, gain control processing including sensitivity correction, gamma-correction processing, synchronization processing (also called “demosaicing”), brightness and color difference signal generation processing, edge enhancement processing, color correction, and the like on the read image data. The image data that is processed by the image processing unit 24 and is processed as a live view image is input to a video random access memory (VRAM) 50.

The image data read from the VRAM 50 is encoded by a video encoder 28 and output to the image monitor 30 provided on a rear surface of the camera. Accordingly, the live view image showing the subject image is displayed on the image monitor 30.

The image data that is processed by the image processing unit 24 and is processed as a still picture or motion picture for recording (brightness data (Y) and color difference data (Cb), (Cr)) is stored again in the memory 48.

A compression/expansion processing unit 26 performs compression processing on the brightness data (Y) and the color difference data (Cb), (Cr) processed by the image processing unit 24 and stored in the memory 48 in a case of recording a still picture or a motion picture. The compressed image data is recorded in the memory card 54 via a media controller 52.

Further, the compression/expansion processing unit 26 performs expansion processing on the compressed image data obtained from the memory card 54 via the media controller 52 in a playback mode. The media controller 52 records and reads the compressed image data to and from the memory card 54.

In the above embodiment, a hardware structure of a processing unit (controller 40 or the like) that executes various kinds of processing includes various processors to be described below. The various processors include a central processing unit (CPU) that is a general-purpose processor functioning as various processing units by executing software (program), a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be configured of one of the various processors or may be configured of two or more processors of the same type or different types (for example, a plurality of FPGAs or a combination of a CPU and an FPGA). In addition, a plurality of processing units may be configured of one processor. As an example of configuring the plurality of processing units by one processor, first, there is a form in which one processor is configured of a combination of one or more CPUs and software, as typified by a computer such as a client or a server, and the one processor functions as the plurality of processing units. Second, there is a form in which a processor that realizes functions of an entire system including a plurality of processing units with one integrated circuit (IC) chip is used, as typified by a system on chip (SoC) or the like. As described above, the various processing units are configured using one or more of the above various processors as a hardware structure.

Furthermore, the hardware structure of those various processors is more specifically an electric circuit (circuitry) in which circuit elements such as semiconductor elements are combined.

### Shake Correction Device

Next, the shake correction device 100 according to the embodiment of the present invention will be described.

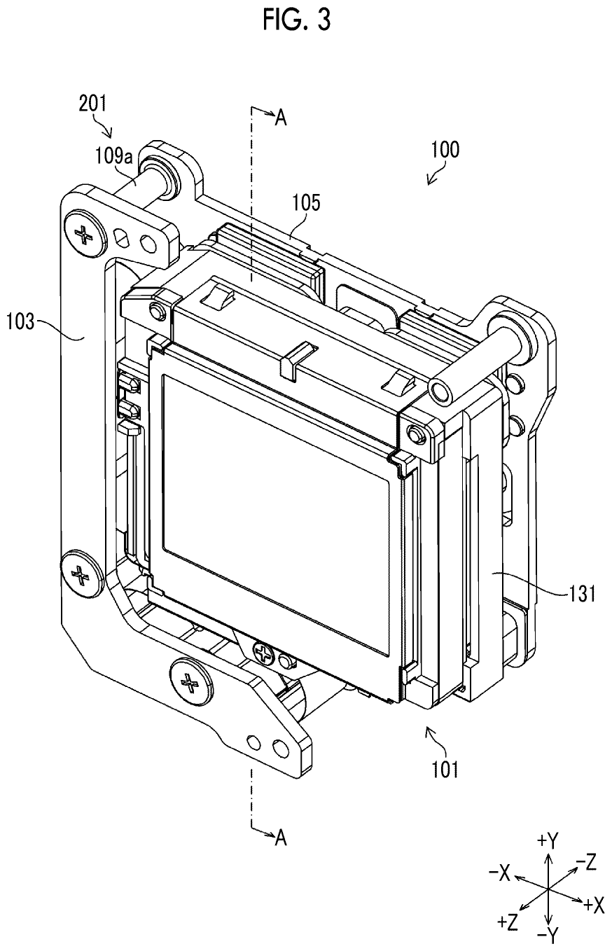

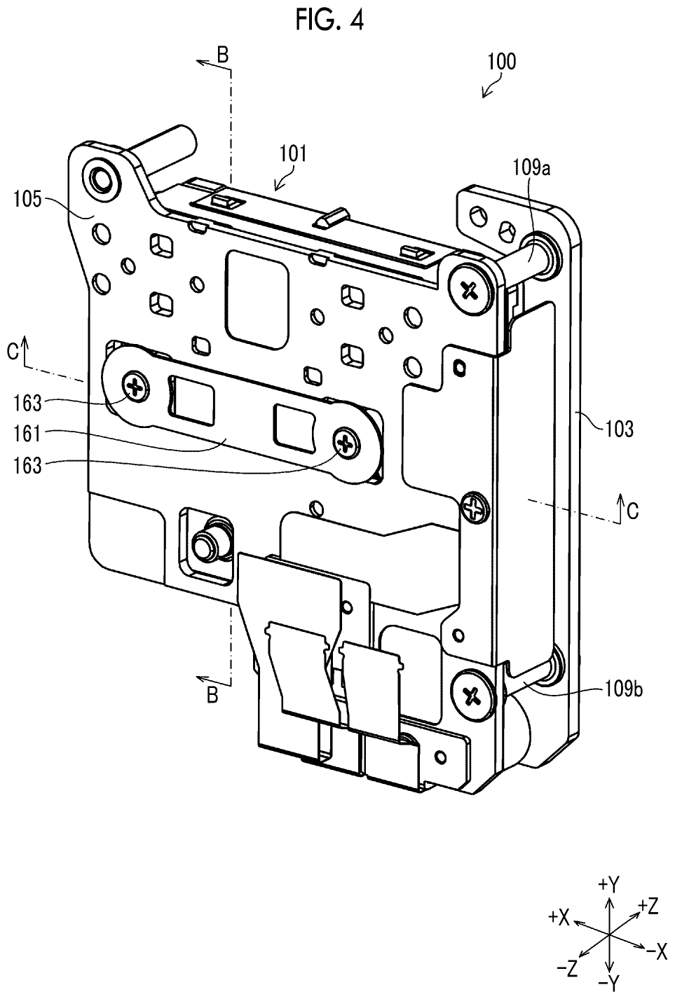

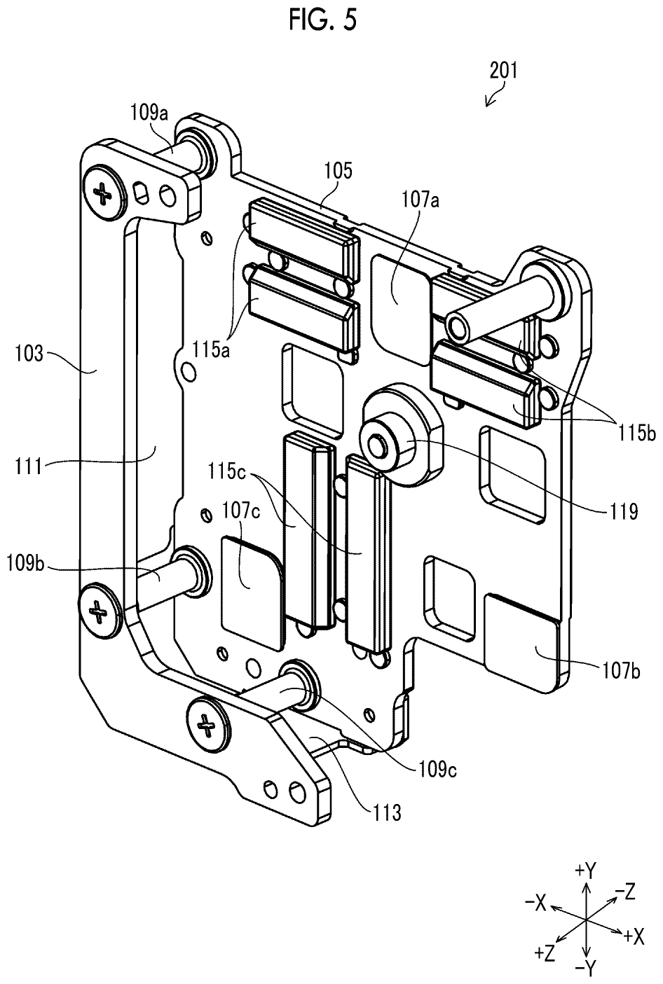

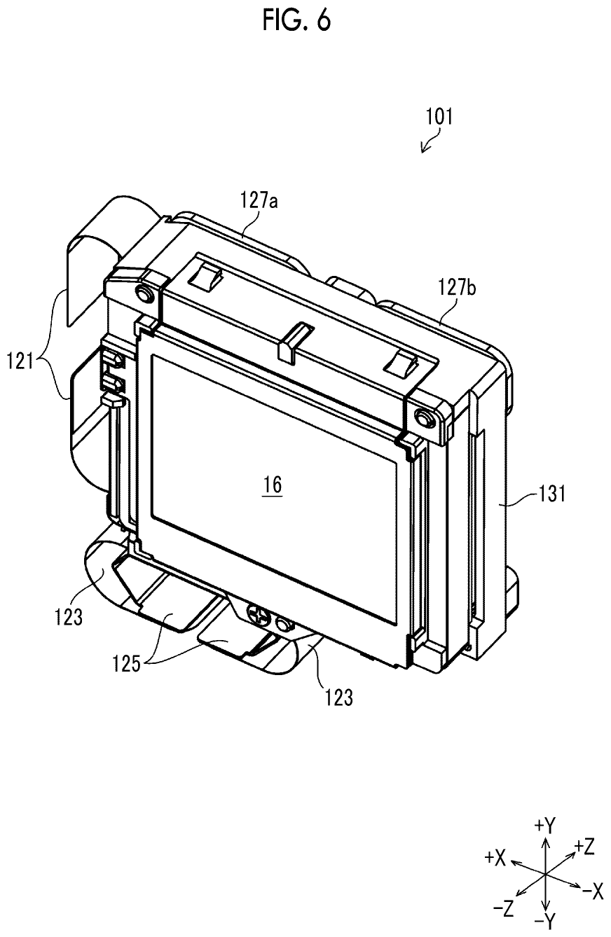

FIGS. 3, 4, 5, and 6 are views showing the shake correction device 100 mounted on the imaging apparatus 10. FIG. 3 is a front perspective view of the shake correction device 100, FIG. 4 is a rear perspective view of the shake correction device 100, FIG. 5 is a front perspective view of a fixed unit 201 constituting the shake correction device 100, and FIG. 6 is a front perspective view of the movable unit 101 constituting the shake correction device 100. In the following description, a front surface is a surface seen from a positive Z-axis side (subject side), and a rear surface is a surface seen from a negative Z-axis side (imager side).

The shake correction device 100 is mainly composed of the movable unit 101 (see FIG. 6) that holds the imaging element 16 and the fixed unit 201 (see FIG. 5) that is fixed to the imaging apparatus main body 2. The movable unit 101 is supported by a support mechanism and is movable along a plane intersecting the optical axis L (X-Y plane perpendicular to the optical axis L in the drawing).

The fixed unit 201 is mainly composed of a base plate 105 and a counter plate 103. The base plate 105 and the counter plate 103 are disposed to face each other and to be spaced apart from each other in a direction along the optical axis L. Further, the base plate 105 and the counter plate 103 are connected by a first shaft 109a, a second shaft 109b, and a third shaft 109c. A first FPC fixing member 111 and a second FPC fixing member 113 are provided between the base plate 105 and the counter plate 103. Here, FPC means a flexible printed circuit. In the following description, a case where the FPC is used as an example of a flexible circuit will be described. However, in the present invention, the flexible circuit is not limited to the FPC.

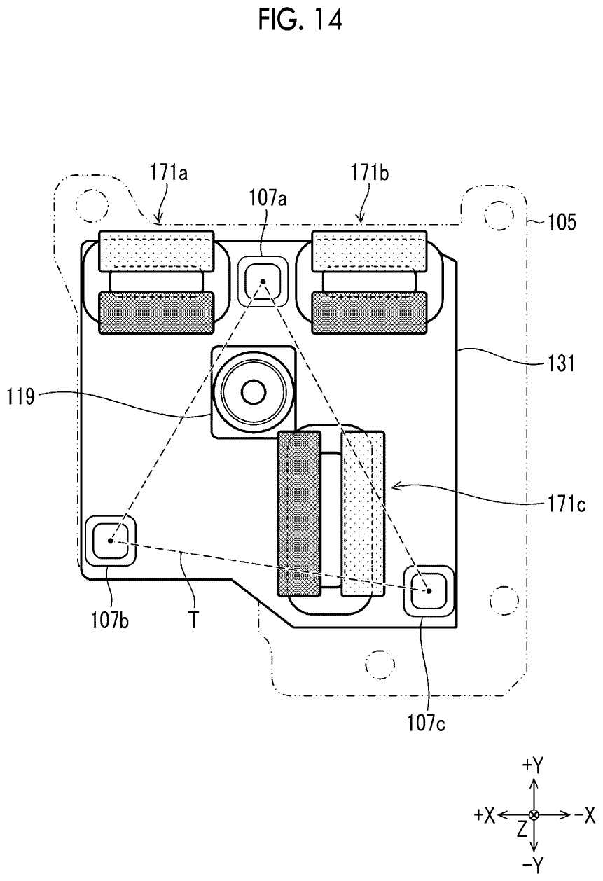

The base plate 105 holds a first magnet 115a, a second magnet 115b, and a third magnet 115c respectively constituting three voice coil motors 171a to 171c (see FIG. 14), which are specific examples of the actuator. In addition, the base plate 105 functions as a yoke of the voice coil motor. In addition, the base plate 105 is provided with a ball plunger constituting a biasing unit 119. The ball plunger will be described below.

The base plate 105 includes ball receiving surfaces 107a to 107c. The movable unit 101 is in contact with the base plate 105 via three balls (not shown). The movable unit 101 is biased by an attractive force of a magnet (not shown) or an elastic force of a spring (not shown) with respect to the base plate 105. Then, the three balls are sandwiched between the movable unit 101 and the base plate 105, and the movable unit 101 is able to move on the X-Y plane by rolling of the three balls.

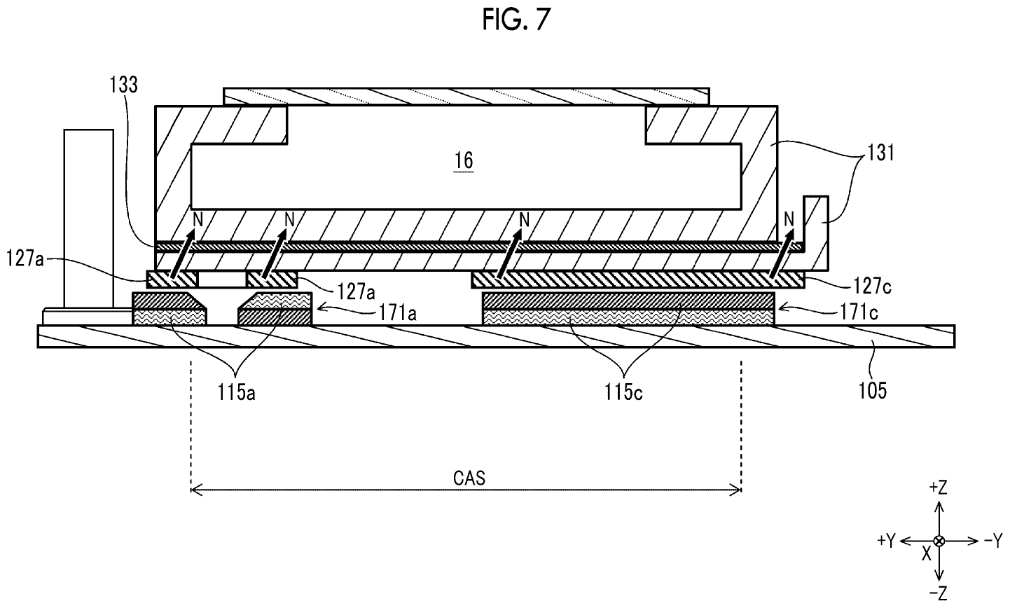

The movable unit 101 is mainly composed of a movable unit frame (holding frame) 131 that holds the imaging element 16. The movable unit frame 131 holds a first winding coil 127a (FIG. 6), a second winding coil 127b (FIG. 6), and a third winding coil 127c (FIG. 7) that constitute the voice coil motors 171a to 171c (see FIG. 14). One end portion of each of a first FPC 121 and a second FPC 123 is connected to a side surface of the movable unit frame 131. In the present invention, the first FPC 121 constitutes a first flexible circuit, and the second FPC 123 constitutes a second flexible circuit.

An end portion of the first FPC 121 is connected to one side surface (first side surface) (in FIG. 6, a Y-Z surface on a positive X-axis side) of the movable unit frame 131. Here, the first FPC 121 has bent portions disposed such that protruding shapes face a positive side and a negative side of a Y axis. In other words, the first FPC 121 has a shape of an elongated ellipse in which two U-shapes are connected by inverting one of them. The first FPC 121 is connected to the driving unit 58.

In addition, the second FPC 123 is connected to another side surface (second side surface) of the movable unit frame 131 (in FIG. 6, an X-Z surface on a negative Y-axis side). Here, the second FPC 123 has bent portions disposed such that protruding shapes face a positive side and a negative side of an X axis. In other words, the second FPC 123 has a shape of an elongated ellipse in which two U-shapes are connected by inverting one of them. The second FPC 123 is connected to the imaging element 16.

In addition, a heat radiation member 125 is connected to the inside of the second FPC 123. The heat radiation member 125 is composed of, for example, a pantograph-type graphite sheet, and radiates heat which is generated by the imaging element 16. In this case, it is desirable that the fixing member of the second FPC 123 is made of a material having a high thermal conductivity, such as copper or aluminum.

### Disposition Position of Coil

Next, disposition positions of the first winding coil 127a, the second winding coil 127b, and the third winding coil 127c constituting the voice coil motors 171a to 171c (see FIG. 14) in the shake correction device 100 will be described.

FIG. 7 is a cross-sectional view schematically showing a cross section taken along the line A-A shown in FIG. 3.

As shown in FIG. 7, in the shake correction device 100, the voice coil motors are disposed on a rear surface of the imaging element 16 (the voice coil motor 171a and the voice coil motor 171b are shown in FIG. 7). In the shake correction device 100, the voice coil motors 171a to 171c are provided in a positional relationship in which a projection region CAS in a thickness direction (Z-axis direction in FIG. 7) of the imaging element 16 overlaps with at least a part of the voice coil motors 171a to 171c. Specifically, in a case shown in FIG. 7, the winding coils 127a to 127c are disposed on a surface of the base plate 105 of the movable unit frame 131 by which the imaging element 16 is held, and magnets 115a to 115c are disposed corresponding to the winding coils 127a to 127c.

In this manner, by disposing the voice coil motors 171a to 171c on the rear surface of the imaging element 16, it is possible to reduce a thickness width (X-Y plane in the drawing) of the shake correction device 100 and to achieve reduction in size.

Here, in a case of performing imaging, a position of the movable unit 101 is controlled by the controller 40. Therefore, a current constantly flows through the winding coils 127a to 127c constituting the voice coil motor while a power of the imaging apparatus 10 is turned on. In addition, due to the current flowing through the winding coils 127a to 127c, magnetic noise (indicated by arrows N in FIG. 7) emitted from the winding coils 127a to 127c (not shown in FIG. 7) reaches the imaging element 16 and there is a problem in that an image quality of an image obtained by the imaging element 16 deteriorates.

For example, in JP2020-170963A described above, in order to suppress such a deterioration in image quality, the magnetic noise is reduced by disposing a conductive member on an outer circumference of the coil. However, in the method disclosed in JP2020-170963A, an influence of the magnetic noise on the imaging element remains because a reaching path of the magnetic noise between the imaging element and the coil is not completely shielded.

Meanwhile, in the shake correction device 100 according to the embodiment of the present invention, an electromagnetic wave shielding member 133 is disposed on a rear surface side of the imaging element 16 between the imaging element 16 and the winding coils 127a to 127c. Here, the electromagnetic wave shielding member 133 may be the same component as a movable unit frame member or a CMOS substrate, and an electromagnetic shielding effect can be obtained by using a conductive material. In this way, by disposing the electromagnetic wave shielding member 133, in the shake correction device 100, it is possible to effectively shield a path in which the magnetic noise N reaches the imaging element 16, and to suppress the magnetic noise reaching the imaging element 16. Accordingly, in the imaging apparatus 10 equipped with the shake correction device 100, it is possible to acquire an image having a good image quality in which the magnetic noise is suppressed.

### Disposition Position of FPC

Next, disposition positions of the first FPC 121 and the second FPC 123 of the shake correction device 100 will be described.

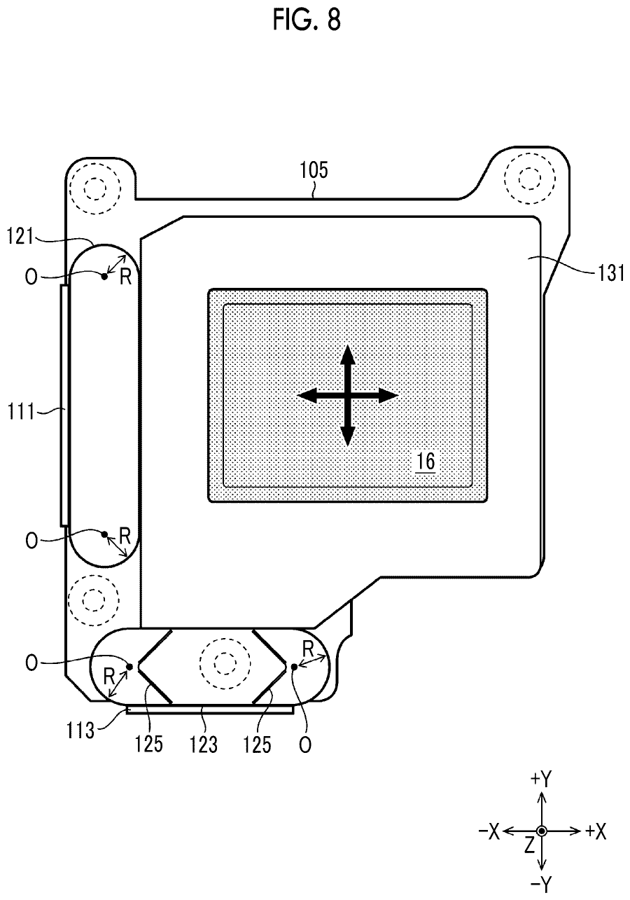

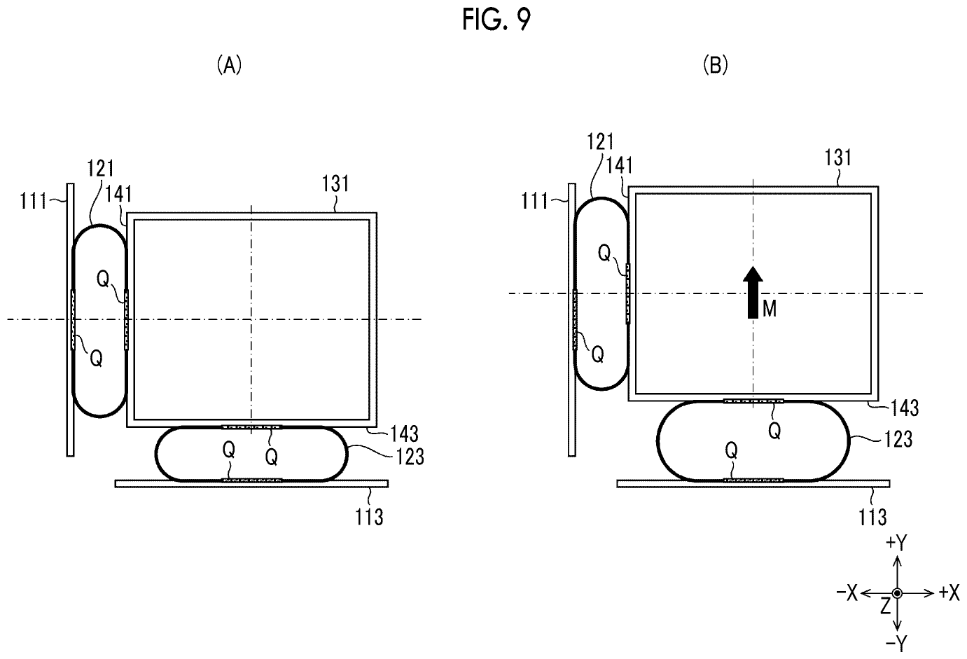

FIG. 8 is a schematic view for explaining the disposition positions of the first FPC 121 and the second FPC 123. FIG. 9 is a view schematically showing shapes of the first FPC 121 and the second FPC 123 in a case where the movable unit frame 131 is moved.

The first FPC 121 is disposed on a first side surface 141 of the movable unit frame 131, and the second FPC 123 is disposed on a second side surface 143 of the movable unit frame 131. A central axis O of a bending radius R of the bent portion of the first FPC 121 and the second FPC 123 is disposed to be parallel to the direction of the optical axis L (Z-axis direction in FIG. 8). The first side surface 141 and the second side surface 143 are side surfaces that intersect each other.

Here, in the shake correction device in the related art, the FPC is disposed on a rear surface of the fixed unit by being bent in a U-shape (see reference 501 in FIG. 23). Therefore, a space for disposing the FPC should be secured between the rear surface (fixed unit) of the shake correction device and the imaging apparatus main body 2. For this reason, a thickness width of the imaging apparatus 10 increases.

Meanwhile, in the shake correction device 100 according to the embodiment of the present invention, since the first FPC 121 and the second FPC 123 are disposed on the first side surface 141 and the second side surface 143 of the movable unit frame 131, an increase in thickness of the imaging element 16 in a thickness direction (Z-axis direction in FIG. 8) can be suppressed.

The first FPC 121 and the second FPC 123 are held such that two bent portions are in a U-shape and have a shape such as an elongated ellipse in which two U-shapes are connected by inverting one of them.

In addition, as shown in FIG. 9, an area Q in which the first FPC 121 is fixed by bonding or the like is designed to be smaller than an area in which the first FPC fixing member 111 and the first FPC 121 are in contact with each other. In addition, an area Q in which the second FPC 123 is bonded and fixed is designed to be smaller than an area in which the second FPC fixing member 113 and the second FPC 123 are in contact with each other. Accordingly, in a case where the movable unit 101 is moved on the X-Y plane, the first FPC 121 and the second FPC 123 are deformed to follow movement of the movable unit frame 131 (see (B) of FIG. 9).

(B) of FIG. 9 is a view for explaining the shapes of the first FPC 121 and the second FPC 123 in a case where the movable unit frame 131 is moved in a direction of an arrow M in the X-Y plane.

In a case where the movable unit frame 131 is moved in the direction of the arrow M, the first FPC 121 is deformed like a crawler to move on a contact surface between the first FPC fixing member 111 and the movable unit frame 131. Meanwhile, the first FPC 121 follows the movable unit frame 131 by increasing a curvature radius of a U-shape in accordance with widening a gap between the second FPC fixing member 113 and the movable unit frame 131. Here, in a case where the gap between the movable unit frame 131 and the second FPC fixing member 113 is reduced, a reaction force due to deformation of the FPC is rapidly increased. Therefore, it is desirable that the gap is 5 mm or more.

As described above, in the shake correction device 100, the first FPC 121 and the second FPC 123 are disposed on the side surfaces of the movable unit frame 131 so that reduction of the imaging element 16 in the thickness direction is achieved.

### Biasing Member

Next, the biasing unit 119 of the shake correction device 100 will be described.

First, a Lorentz force acting on a winding coil in a configuration of a general voice coil motor will be described.

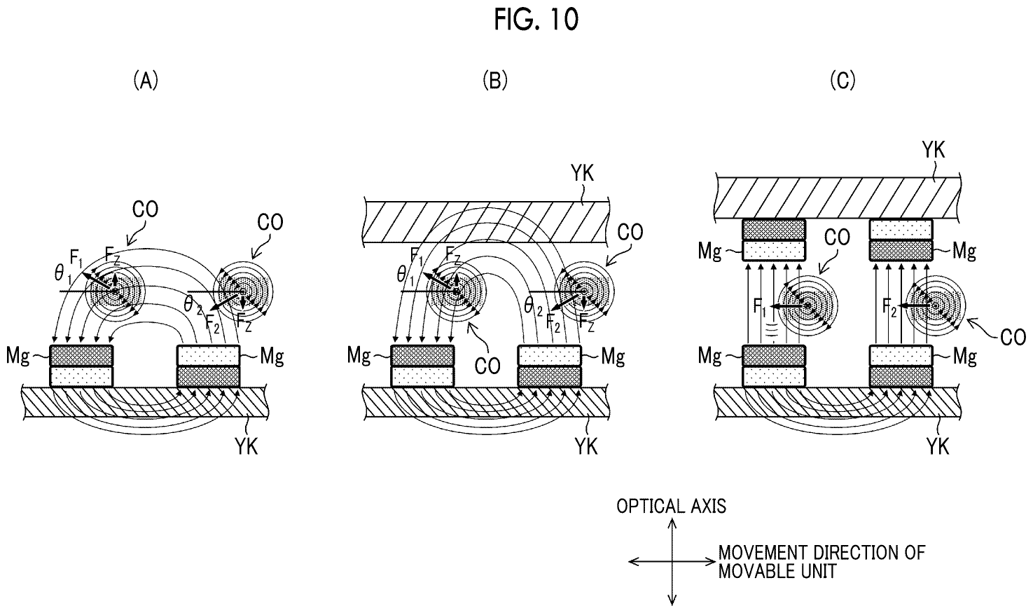

FIG. 10 is a view for explaining the Lorentz force acting on the winding coil in the configuration of the voice coil motor. (A) of FIG. 10 shows a Lorentz force F (indicated by F₁ and F₂ in the drawing) acting on a winding coil CO in a case where an opposing yoke YK and an opposing magnet Mg are not provided, (B) of FIG. 10 shows the Lorentz force F (indicated by F₁ and F₂ in the drawing) acting on the winding coil CO in a case where only the opposing yoke YK is provided, and (C) of FIG. 10 shows the Lorentz force F (indicated by F₁ and F₂ in the drawing) acting on the winding coil CO in a case where the opposing yoke YK and the opposing magnet Mg are provided.

In a case where a current flows through the winding coil CO, a magnetic field is formed on an outer peripheral portion of the winding coil CO, and the Lorentz force F is generated as a driving force by interaction with a magnetic circuit of the voice coil motor.

Since the opposing magnet Mg and the opposing yoke YK are not provided in a case shown in (A) of FIG. 10 and the opposing magnet Mg is not provided in a case shown in (B) of FIG. 10, the vicinity of the winding coil CO does not have a uniform parallel magnetic field, and a Lorentz force Fz in a direction parallel to an optical axis direction acts on the winding coil CO.

On the other hand, since the opposing yoke YK and the opposing magnet Mg are provided in a case shown in (C) of FIG. 10, the vicinity of the winding coil CO has a uniform parallel magnetic field, and the Lorentz force F becomes parallel to a movement direction of the movable unit 101.

As described above, in a case where the opposing yoke YK and the opposing magnet Mg are provided, the Lorentz force Fz becomes smaller because the magnetic field in the vicinity of the winding coil CO approaches a uniform parallel magnetic field (a case of (C) of FIG. 10), and in a case where there is no opposing yoke and/or opposing magnet Mg, the Lorentz force Fz becomes larger because a magnetic force line in the vicinity of the winding coil CO is bent (a case of (A) and (B) of FIG. 10).

Here, in the shake correction device 100, in a case where the Lorentz force Fz is larger than a force for biasing the movable unit 101 to the fixed unit 201, the movable unit 101 floats from the fixed unit 201, and tilting of an image plane of the imaging element 16 occurs. Therefore, in the shake correction device 100, it is necessary to always perform biasing using a biasing force larger than the Lorentz force Fz within a movable range of the movable unit 101.

Next, a case where the movable unit is biased with respect to the fixed unit by a magnetic spring will be described.

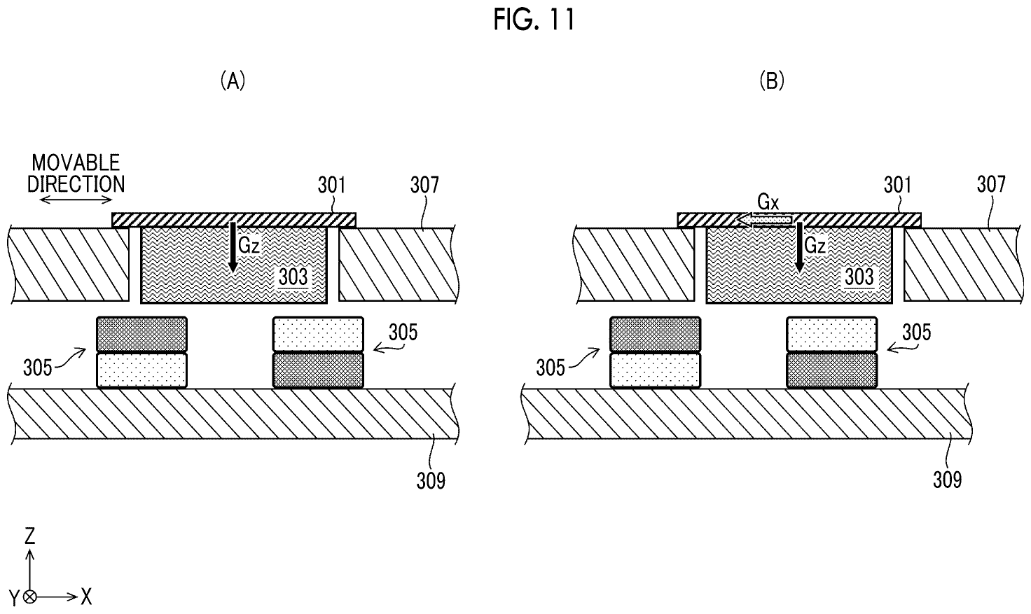

FIG. 11 is a schematic view of a case where the movable unit is biased by a general magnetic spring.

In FIG. 11, a magnet 305 and a magnetic plate 301 form a magnetic spring, and the movable unit 307 holding the coil 303 is biased toward the fixed unit 309 with a biasing force Gz by using an attractive force of the magnetic spring.

As shown in (A) of FIG. 11, in a case where the movable unit 307 is positioned at the center, biasing can be performed mainly by the biasing force Gz parallel to the Z-axis direction. On the other hand, as shown in (B) of FIG. 11, in a case where the movable unit 307 is moved in an X-axis direction, a biasing force Gx is generated together with the biasing force Gz. This is because the biasing force is applied via a member having a certain area, such as the magnetic plate 301.

Here, in general, the movable unit 307 is biased to the fixed unit 309 by a coil spring or a magnetic spring. Even in a case where the biasing force is applied using the coil spring, as with the above-described magnetic spring, in a case where the biasing force (Gz) in the Z direction increases, the force (Gx) in the X direction also increases, and a thrust force for driving the movable unit 101 increases.

Therefore, in the shake correction device 100, the biasing unit 119 that biases the movable unit 101 by point contact is provided to suppress the generation of the above-described force (Gx) parallel to the X direction, and to suppress the increase in thrust force for driving the movable unit 101.

In the shake correction device 100, a plunger capable of performing point contact is employed as the biasing unit 119, and the biasing force Gx larger than the Lorentz force Fz is applied. Since the plunger employs a structure in which a biasing force is applied by point contact by pressing a ball, the reaction force (Gx) in a driving direction (X direction) can be suppressed.

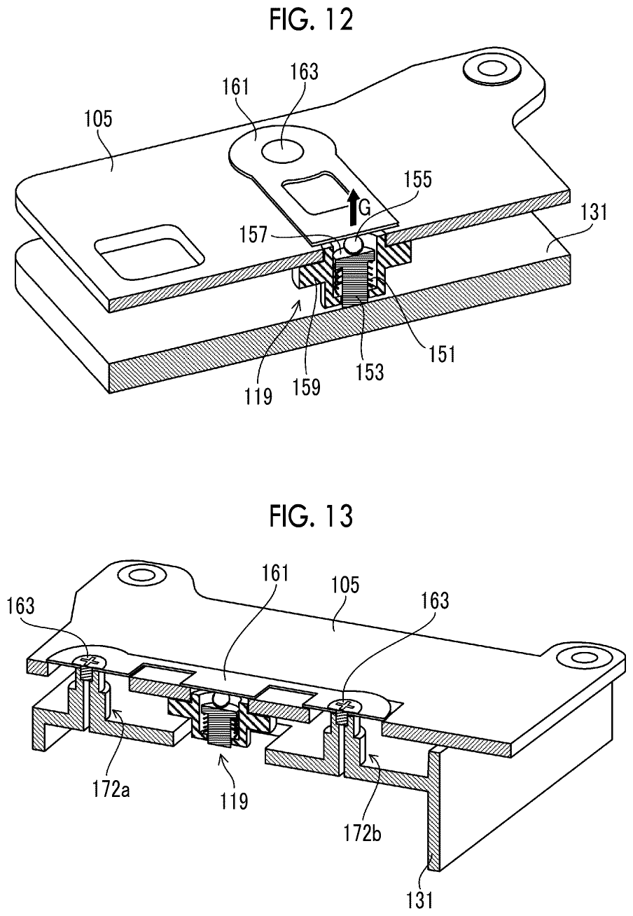

FIGS. 12 and 13 are views showing an example of a ball plunger constituting the biasing unit 119 of the shake correction device 100. FIG. 12 is a view schematically showing a cross section taken along the line B-B in FIG. 4, and FIG. 13 is a view schematically showing a cross section taken along the line C-C in FIG. 4.

As shown in FIG. 12, the ball plunger constituting the biasing unit 119 is composed of a plunger 153, a coil spring 151, a ball 155, a plunger-side ball receiving surface 157, and a plunger guide 159. The ball 155 is pressed against a fixed unit-side ball receiving surface 161 by the ball plunger, and the biasing force G acts on the fixed unit-side ball receiving surface 161.

The plunger guide 159 is attached to the base plate 105. The coil spring 151, the plunger 153 to which the plunger-side ball receiving surface 157 is attached, and the ball 155 are disposed inside the plunger guide 159 having a tubular shape. The plunger 153 functions as a movement piece that moves by an anti-compression reaction force of the coil spring 151, and presses the ball 155 disposed on the plunger-side ball receiving surface 157 at an end portion of the plunger 153 against the fixed unit-side ball receiving surface 161.

The fixed unit-side ball receiving surface 161 is attached to the movable unit frame 131 via a screw 163 (see FIG. 13) and can press the movable unit frame 131 toward the base plate 105.

Here, in a case where the movable unit frame 131 is moved, the ball 155 rolls between the plunger-side ball receiving surface 157 and the fixed unit-side ball receiving surface 161. Therefore, the reaction force in the driving direction (for example, the X direction in FIG. 10) is only a rolling resistance of the ball 155. Since this rolling resistance is smaller than the attractive force (Gx) of the magnetic spring shown in FIG. 10 or the force of the coil spring, the movable unit 101 can be moved with a smaller driving force.

As shown in FIG. 13, the fixed unit-side ball receiving surface 161 is connected to the movable unit frame 131 via a protrusion portion 172a and the screw 163, and a protrusion portion 172b and the screw 163 provided on the movable unit frame 131. As described above, it is desirable that the protrusion portions 172a and 172b for performing connection to the fixed unit-side ball receiving surface 161 are formed integrally with the movable unit frame 131.

Next, the disposition position of the biasing unit 119 will be described.

FIG. 14 is a view for explaining the disposition position of the biasing unit 119.

It is desirable that the biasing unit 119 is provided inside a triangle T connecting the ball receiving surfaces 107a to 107c provided on the base plate 105. As described above, the movable unit frame 131 is biased to come into contact with the base plate 105 via the three balls. Therefore, by providing the biasing unit 119 inside the triangle T, the movable unit 101 can be stably biased to the base plate 105 side.

### Disposition of Hall Sensor and Shape of Magnet

Next, the disposition of the hall sensor and the shape of the magnet will be described. The shake correction device 100 detects the position of the movable unit 101 with the shake sensor 66 composed of the hall sensor, and the controller 40 performs the control of suppressing the shake. Here, in the shake correction device 100, the magnet constituting the hall sensor is composed of a part or all of the magnets 115a to 115c constituting the voice coil motors 171a to 171c. In addition, hall elements constituting the hall sensor are disposed inside the winding coils 127a to 127c of the voice coil motors 171a to 171c.

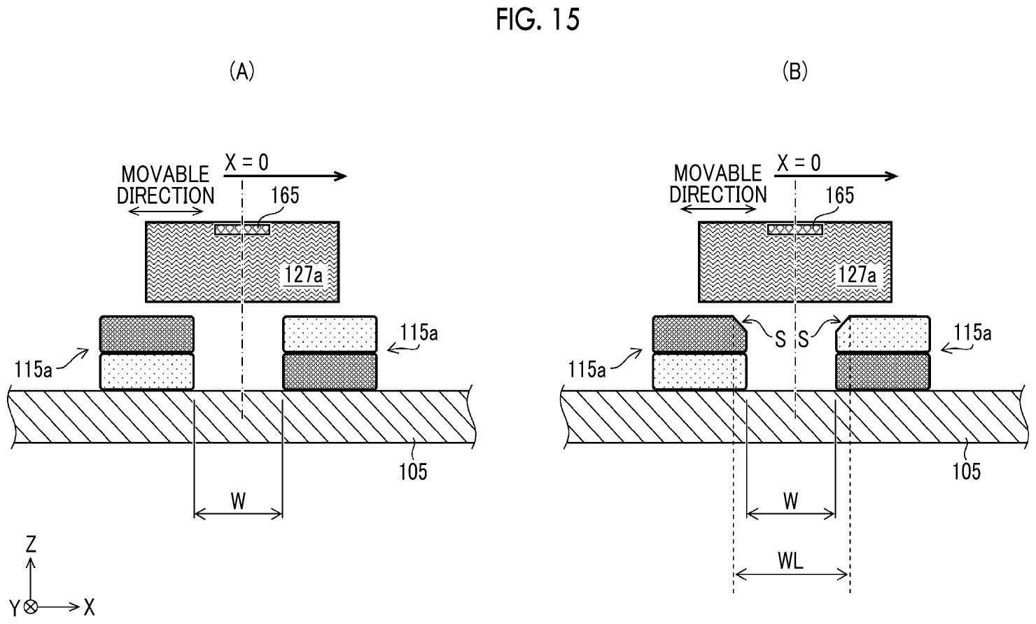

FIG. 15 is a schematic view for explaining the disposition of the hall sensor and the shape of the magnet. In the following description, the hall sensor composed of the magnet 115a and the winding coil 127a will be described. However, the same description will be applied to the hall sensor composed of the magnets 115b and 115c and the winding coils 127b and 127c.

A hall element 165 is disposed inside the winding coil 127a constituting the voice coil motor provided in the movable unit frame 131. Then, by detecting the position of the hall element 165 from a change in the magnetic field of the magnet 115a disposed on the base plate 105, the controller 40 calculates a movement amount of the movable unit frame 131.

Here, the magnets 115a (magnet portion) composed of a pair of magnets are disposed at a magnet gap W. From the viewpoint of reduction in size, it is desirable to set the magnet gap W to be small. However, in a case where the magnet gap W decreases, a linearity error of hole position detection may deteriorate as described below.

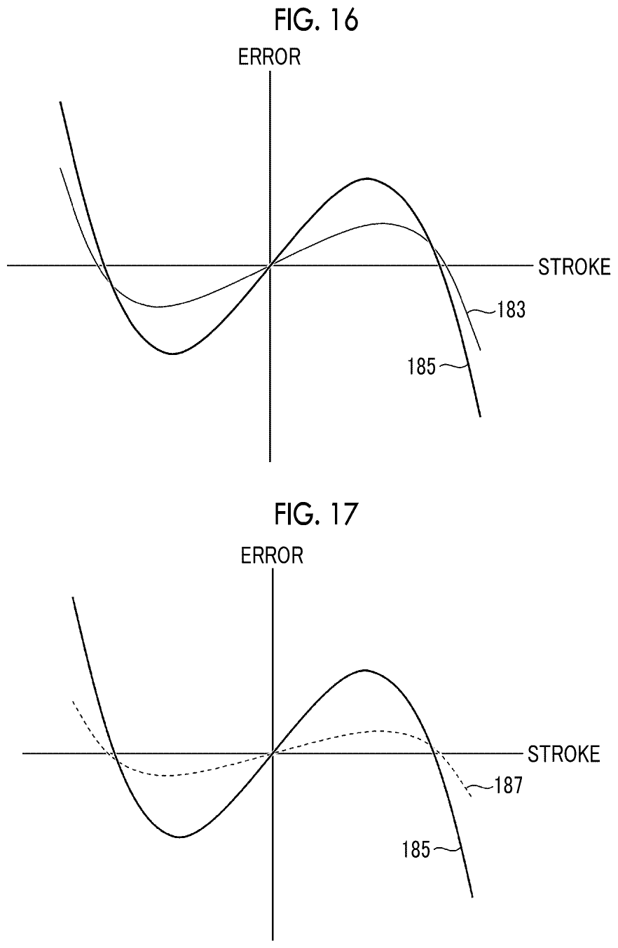

FIG. 16 is a view showing a relationship between the magnet gap W and the linearity error. In FIG. 16, a vertical axis represents an error, and a horizontal axis represents a stroke of the movable unit 101.

FIG. 16 shows linearity errors in a case where the magnet gap W=2 (indicated by reference 183) and in a case where the magnet gap W=1.5 (indicated by reference 185). As shown in the drawing, in a case where the magnet gap W decreases, an error increases and the linearity error of the hole position detection deteriorates.

Therefore, in the shake correction device 100, as shown in (B) of FIG. 15, a gap between distal end portions of a pair of the magnets 115a is widened from the magnet gap W (first gap) to a magnet gap WL (second gap) by adding a chamfer shape S by cutting opposing corner portions.

FIG. 17 is a view showing a relationship between linearity errors of the forms shown in (A) and (B) of FIG. 15. In FIG. 17, a vertical axis represents an error, and a horizontal axis represents a stroke of the movable unit 101.

The linearity error in a case where the magnet 115a does not have the chamfer shape S at the magnet gap W (in a case of (A) of FIG. 15) is indicated by reference 185. Further, the linearity error in a case where the magnet 115a has the chamfer shape S at the same magnet gap W (in a case of (B) of FIG. 15) is indicated by reference 187. As shown in the drawing, even in a case where the magnet gap W is the same, the magnet gap WL between the distal end portions is widened by adding the chamfer shape S, and the linearity error of the position detection is improved. Therefore, it is desirable that the magnets 115a to 115c of the shake correction device 100 are also provided with the chamfer shape S, so that the position of the movable unit 101 can be detected accurately.

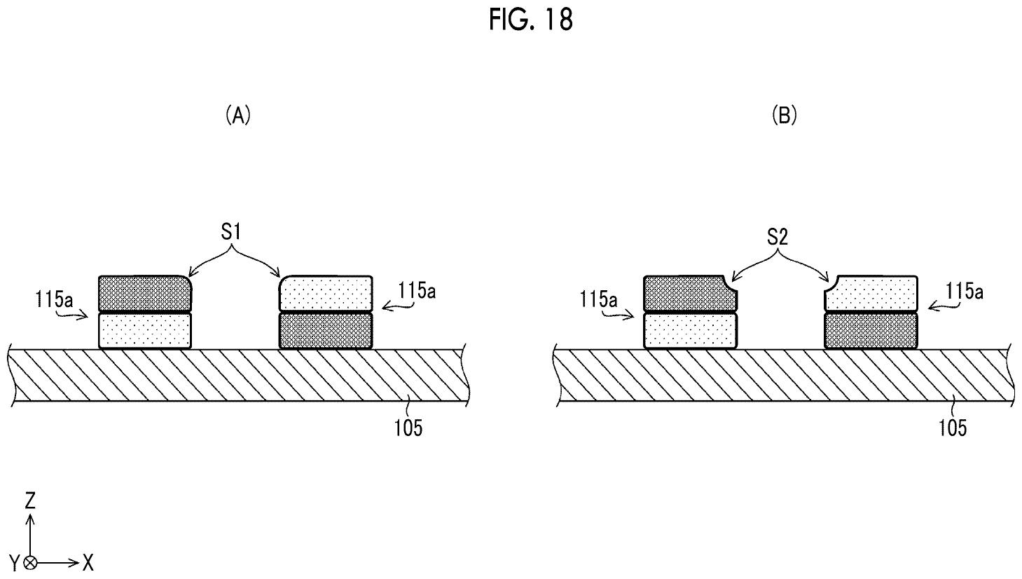

FIG. 18 is a view showing a modification example of the chamfer shape S of the magnet 115a.

In the above-mentioned example, the chamfer shape S is added to the magnet 115a so that the magnet gap between the distal end portions of the magnets 115a is widened and the linearity error is improved. However, the shape applied to the distal end portions of the magnets 115a is not particularly limited as long as the gap between the distal end portions of the magnets 115a can be widened. For example, as shown in (A) of FIG. 18, the distal end portion of the magnet 115a may have an R-shape S1 that is rounded. Further, as shown in (B) of FIG. 18, the distal end portion of the magnet 115a may have an inverse R-shape S2. As described above, in a case where the distal end portions of the magnets 115a are processed into a shape other than the chamfer shape S to widen the magnet gap WL of the distal end portions, the linearity error can be improved as in a case where the above-described chamfer shape S is added.

### Spring Property (Spring Constant) of FPC

Next, the spring property of the FPC will be described.

As described above, in the shake correction device 100, the first FPC 121 and the second FPC 123 are disposed on the first side surface 141 and the second side surface 143 of the movable unit frame 131, respectively. In addition, the first FPC 121 and the second FPC 123 are bent in a U-shape and have spring properties to exert a force on the movable unit frame 131. In a case of considering a spring constant of the movable unit 101, spring components of a magnetic spring, a coil spring, an FPC reaction force, and a graphite sheet reaction force described below are taken into consideration.

The magnetic spring is a force caused by a suction force between the magnet and the magnetic plate. There is almost no temperature dependence, and the reaction force changes quadratically with respect to a displacement amount.

The coil spring is a force caused by a tension spring. There is almost no temperature dependence, and the force is in a proportional relationship with the displacement amount.

The FPC reaction force is a force caused by a deformation resistance of the FPC. There is a temperature dependence, and in a low temperature environment, the FPC becomes hard so that the deformation resistance increases (the spring constant increases).

The graphite sheet reaction force is a force caused by a deformation resistance of a graphite sheet. There is a temperature dependence, and in a low temperature environment, the graphite sheet becomes hard so that the deformation resistance increases (the spring constant increases).

In addition, a resonance frequency f of the movable unit 101 is given by the following equation.

$$f = \frac{1}{2 π} \sqrt{\frac{k}{m}}$$

In the above equation, k represents a spring constant. In the following description, in order to consider the temperature dependence of the spring constant, a sum of the FPC reaction force and the graphite sheet reaction force will be considered. In addition, m represents a weight of the movable unit 101.

Although the weight m of the movable unit is invariable, the spring constant k changes depending on an environment (for example, the environmental temperature), and thus the resonance frequency f also changes.

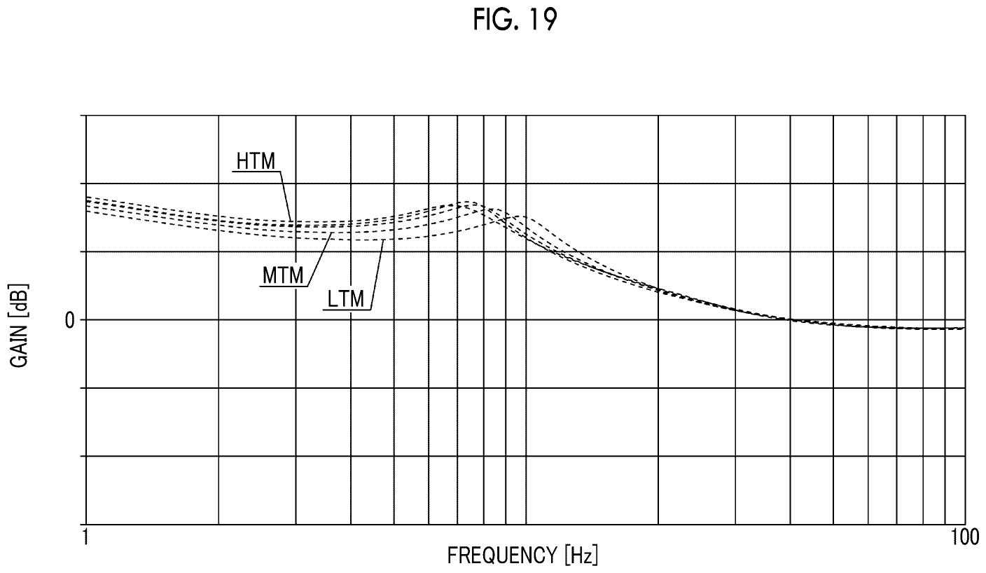

FIG. 19 is a view showing a relationship between a temperature change and a primary resonance frequency of the shake correction device 100. In FIG. 19, a horizontal axis represents a frequency and a vertical axis represents a gain.

HTM is a frequency of the shake correction device 100 in a high temperature environment, MTM is a frequency of the shake correction device 100 in a normal temperature environment, and LTM is a frequency of the shake correction device 100 in a low temperature environment.

As shown in FIG. 19, the primary resonance frequency changes depending on the temperature, and the primary resonance frequency shifts to a higher range as the temperature decreases. The controller 40 can perform more accurate shake correction by performing the shake correction based on the change in the primary resonance frequency depending on the environmental temperature.

Therefore, in the shake correction device 100, even in a case where the environmental temperature is between a high temperature and a low temperature, a control is performed according to the environmental temperature in order to accurately perform the shake correction.

Specifically, the controller 40 measures the environmental temperature by the temperature sensor 68 of the imaging apparatus 10, and selects a servo control parameter corresponding to the measured temperature to control the movable unit 101. Thus, the shake correction device 100 can perform shake correction with high accuracy even at various environmental temperatures.

### Bending of FPC

Next, the bending of the FPC will be described.

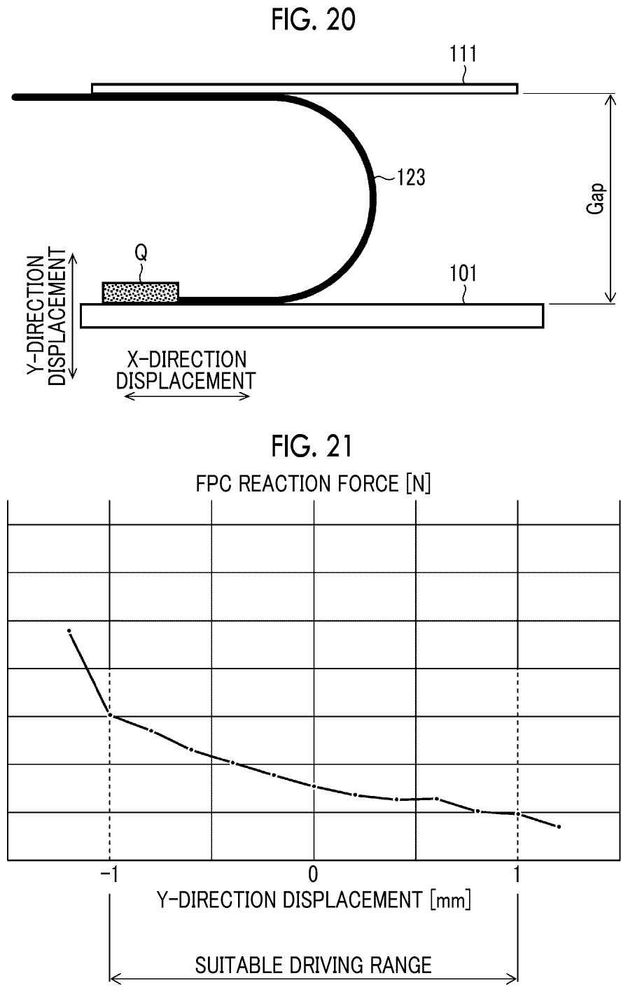

FIG. 20 is a view schematically showing a one-side half of the second FPC 123 shown in FIG. 9. In the following description, although the second FPC 123 will be described, the same description will be applied to the first FPC 121.

In a case where the movable unit 101 is driven in the Y direction, Gap of the second FPC 123 changes following a displacement of the movable unit 101. Since the second FPC 123 is elastically deformed, a reaction force is generated in response to the displacement. It is desirable that the Gap is small from the viewpoint of reduction in size of the shake correction device 100. However, in a case where the Gap is smaller than a certain value, the reaction force of the second FPC 123 is rapidly increased.

FIG. 21 is a view showing an example of a displacement in the Y direction and the reaction force of the second FPC 123. In FIG. 21, a horizontal axis represents the displacement in the Y direction, and a vertical axis represents the FPC reaction force. Furthermore, FIG. 21 shows an example of a reaction force in a case where a total thickness of a flexible printed circuit (FPC) is 50 μm.

Here, in order not to change the resonance frequency of the movable unit 101, it is desirable to set a linear region of the reaction force of the FPC as a driving range.

In this way, by designing the Gap according to elastic characteristics of the flexible printed circuit, the movable unit 101 can be controlled with high accuracy.

### Position of Hall Sensor

Next, a modification example of the disposition position of the hall elements constituting the hall sensor according to the embodiment of the present invention will be described.

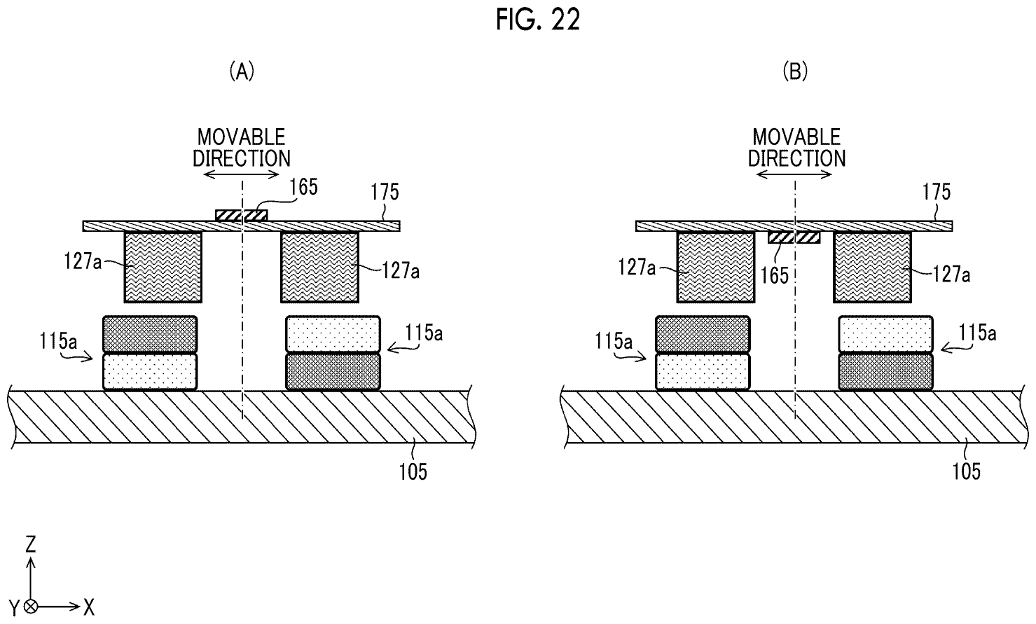

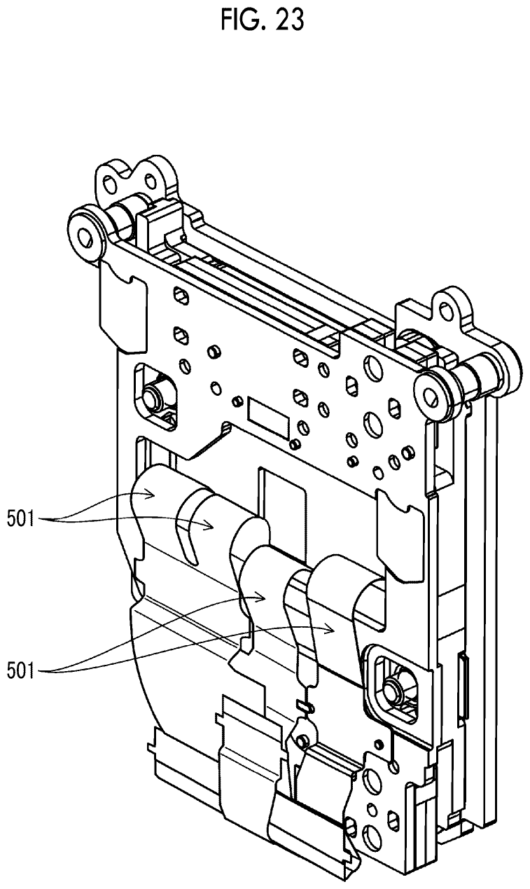

FIG. 22 is a view for explaining a disposition position of the hall element 165 according to the embodiment of the present invention.

(A) of FIG. 22 shows a case where mounting surfaces of the hall element 165 and the winding coil 127a are different from each other, and (B) of FIG. 22 shows a case where mounting surfaces of the hall element 165 and the winding coil 127a are the same.

In the shake correction device 100, by disposing the voice coil motor on the rear surface of the imaging element 16, the hall element 165 and the winding coil 127a can be mounted on different surfaces via an FPC 175 as shown in (A) of FIG. 22, or the hall element 165 and the winding coil 127a can be mounted on the same surface of the FPC 175 as shown in (B) of FIG. 22. In this way, in the shake correction device 100, various forms can be employed by disposing the voice coil motor on the rear surface of the imaging element 16.

### Appendix

The present disclosure described above includes the inventions of the following aspects.

### Aspect 1

A shake correction device that drives an imaging element by an actuator to perform shake correction, the shake correction device comprising: a fixed unit that includes a first fixing member provided with a magnet and a yoke of the actuator; a movable unit that includes a holding frame holding the imaging element and a coil of the actuator and is configured to move within a plane intersecting an optical axis; and a biasing unit that biases the movable unit toward the first fixing member by point contact along an optical axis direction, in which the actuator is disposed on a rear surface of the imaging element.

### Aspect 2

The shake correction device according to Aspect 1, in which the imaging element and the actuator are provided in a positional relationship in which a projection region of the imaging element in a thickness direction and at least a part of the actuator overlap with each other.

### Aspect 3

The shake correction device according to Aspect 1 or 2, in which a first flexible circuit connected to the actuator and a second flexible circuit connected to the imaging element are attached to a side surface of the holding frame.

### Aspect 4

The shake correction device according to Aspect 3, in which the holding frame includes at least a first side surface and a second side surface intersecting the first side surface, and the first flexible circuit is attached to the first side surface, and the second flexible circuit is attached to the second side surface.

### Aspect 5

The shake correction device according to Aspect 3 or 4, in which at least one of the first flexible circuit or the second flexible circuit is attached while having a bent portion, and the bent portion changes following movement of the holding frame.

### Aspect 6

The shake correction device according to any one of Aspects 3 to 5, further comprising a controller that inputs a drive signal for suppressing resonance of the movable unit to the actuator.

### Aspect 7

The shake correction device according to Aspect 6, further comprising a temperature acquisition unit that acquires an environmental temperature, in which the drive signal is input to the actuator based on the environmental temperature acquired by the temperature acquisition unit.

### Aspect 8

The shake correction device according to Aspect 7, in which the controller selects the drive signal from among a plurality of the drive signals based on the environmental temperature and inputs the selected drive signal to the actuator.

### Aspect 9

The shake correction device according to any one of Aspects 1 to 8, in which the biasing unit includes a ball plunger.

### Aspect 10

The shake correction device according to any one of Aspects 1 to 9, further comprising a hall sensor that detects a position of the imaging element, in which the magnet of the actuator is used as a magnet that generates a magnetic field detected by the hall sensor, and a hall element constituting the hall sensor is disposed inside the coil of the actuator.

### Aspect 11

The shake correction device according to Aspect 10, in which the magnet of the actuator is a magnet portion composed of a pair of magnets disposed at a first gap on the yoke, and opposing corner portions of distal end portions of the pair of magnets are cut, and a second gap between the distal end portions is wider than the first gap.

### Aspect 12

The shake correction device according to any one of Aspects 1 to 11, in which an electromagnetic wave shielding member is disposed between a rear surface side of the imaging element and the coil.

### Aspect 13

The shake correction device according to any one of Aspects 1 to 12, in which the actuator is a voice coil motor.

### Aspect 14

An imaging apparatus comprising the shake correction device according to any one of Aspects 1 to 13.

Although examples of the present invention have been described above, it goes without saying that the present invention is not limited to the above-described embodiment and various modifications can be made without departing from the scope of the present invention.

### EXPLANATION OF REFERENCES

1: subject
2: imaging apparatus main body
10: imaging apparatus
16: imaging element
40: controller
58: driving unit
66: shake sensor
68: temperature sensor
100: shake correction device
101: movable unit
103: counter plate
105: base plate
107a to 107c: ball receiving surface
111: first FPC fixing member
113: second FPC fixing member
115a to 115c: magnet
119: biasing unit
121: first FPC
123: second FPC
125: heat radiation member
127a to 127c: winding coil
131: movable unit frame
133: electromagnetic wave shielding member
171a to 171c: voice coil motor

What is claimed is:

1. A shake correction device that drives an imaging element by an actuator to perform shake correction, the shake correction device comprising:
a fixed unit that includes a first fixing member provided with a magnet and a yoke of the actuator;
a movable unit that includes a holding frame holding the imaging element and a coil of the actuator and is configured to move within a plane intersecting an optical axis; and
a biasing unit that biases the movable unit toward the first fixing member by point contact along an optical axis direction,
wherein the actuator is disposed on a rear surface of the imaging element.

2. The shake correction device according to claim 1,
wherein the imaging element and the actuator are provided in a positional relationship in which a projection region of the imaging element in a thickness direction and at least a part of the actuator overlap with each other.

3. The shake correction device according to claim 1,
wherein a first flexible circuit connected to the actuator and a second flexible circuit connected to the imaging element are attached to a side surface of the holding frame.

4. The shake correction device according to claim 3,
wherein the holding frame includes at least a first side surface and a second side surface intersecting the first side surface, and
the first flexible circuit is attached to the first side surface, and the second flexible circuit is attached to the second side surface.

5. The shake correction device according to claim 3,
wherein at least one of the first flexible circuit or the second flexible circuit is attached while having a bent portion, and
the bent portion changes following movement of the holding frame.

6. The shake correction device according to claim 3, further comprising:
a controller that inputs a drive signal for suppressing resonance of the movable unit to the actuator.

7. The shake correction device according to claim 6, further comprising:
a temperature acquisition unit that acquires an environmental temperature,
wherein the drive signal is input to the actuator based on the environmental temperature acquired by the temperature acquisition unit.

8. The shake correction device according to claim 7,
wherein the controller selects the drive signal from among a plurality of the drive signals based on the environmental temperature and inputs the selected drive signal to the actuator.

9. The shake correction device according to claim 1,
wherein the biasing unit includes a ball plunger.

10. The shake correction device according to claim 1, further comprising:
a hall sensor that detects a position of the imaging element,
wherein the magnet of the actuator is used as a magnet that generates a magnetic field detected by the hall sensor, and
a hall element constituting the hall sensor is disposed inside the coil of the actuator.

11. The shake correction device according to claim 10,
wherein the magnet of the actuator is a magnet portion composed of a pair of magnets disposed at a first gap on the yoke, and
opposing corner portions of distal end portions of the pair of magnets are cut, and a second gap between the distal end portions is wider than the first gap.

12. The shake correction device according to claim 1,
wherein an electromagnetic wave shielding member is disposed between a rear surface side of the imaging element and the coil.

13. The shake correction device according to claim 1,
wherein the actuator is a voice coil motor.

14. An imaging apparatus comprising:
the shake correction device according to claim 1.
